(19) United States
(12) Patent Application Publication
(10) Pub. No.: US 2010/0043201 A1
(43) Pub. Date: Feb. 25, 2010

(54) ENDOSCOPE BENDING TUBE AND METHOD FOR MANUFACTURING THEREOF

(75) Inventor: Kazuo Kotani, Hachioji-shi (JP)

Correspondence Address: Frishauf, Holtz Goodman & Chick, P.C., 220 Fifth Avenue- 16th Floor, New York, NY, 10001-7708, US

(73) Assignee: Olympus Corporation, Tokyo (JP)

(21) Appl. No.: 12/540,482

(22) Filed: Aug. 13, 2009

(30) Foreign Application Priority Data
Aug. 25, 2008 (JP) 2008-215831

(51) Int. Cl. B23P 17/00

(52) U.S. Cl. 29/592

(57) ABSTRACT

A method is adapted to manufacture an endoscope bending tube from a board-shaped member by a press processing. The endoscope bending tube includes a plurality of bending parts each of which includes a tubular main portion and an extending portion extended from the main portion. The method includes forming a thickness increasing portion in which a thickness is locally increased, on the board-shaped member, by a press processing, and forming the extending portion in the thickness increasing portion, by a press processing.

### CROSS-REFERENCE TO RELATED APPLICATIONS

This application is based upon and claims the benefit of priority from prior Japanese Patent Application No. 2008-215831, filed Aug. 25, 2008, the entire contents of which are incorporated herein by reference.

### BACKGROUND OF THE INVENTION

1. Field of the Invention

The present invention relates to an endoscope bending tube and a method for manufacturing thereof.

2. Description of the Related Art

An endoscope includes an elongated insertion portion configured to be inserted into a cavity in the body, and a bending portion is provided on the distal end portion of the insertion portion and configured to be actuated to be bent. The bending portion includes a bending tube forming a framework of the bending portion, and a great number of substantially tubular bending parts are coupled to each other so as to be coaxial and rotatable relative to each other. In Jpn. UM. Appln. KOKAI Publication Nos. 55-154001 and 3-13103, and Jpn. Pat. Appln. KOKAI Publication No. 2001-104239, a method for manufacturing a bending tube by a press processing is disclosed. For example, regarding a bending tube disclosed in Jpn. Pat. Appln. KOKAI Publication No. 2001-104239, in the bending part, both pairs of tongue portions symmetrical with each other relative to the central axis are axially protruded from both the end surfaces of a tubular portion, respectively. Both the pairs of tongue portions of both the bending parts adjacent to each other are overlapped with each other, convex portions are radially and inwardly formed on one pair of tongue portions on the radial outside, through bores are radially formed through the other pair of tongue portions on the radial inside, and the convex portions are fitted into the through bore so as to be rotatable. When manufacturing the bending tube, regarding one bending part in which the convex portion is not formed and the other bending part in which the through bore is formed, after the tongue portions are overlapped with each other, the tongue portion of the one bending part is pressed from the radial outside to form the convex portion and fit the convex portion into the through bore of the tongue portion of the other bending part.

### BRIEF SUMMARY OF THE INVENTION

In an aspect of the present invention, a method is adapted to manufacture an endoscope bending tube from a board-shaped member by a press processing. The endoscope bending tube includes a plurality of bending parts each of which includes a tubular main portion and an extending portion extended from the main portion. The method includes: forming a thickness increasing portion in which a thickness is locally increased, on the board-shaped member, by a press processing; and forming the extending portion in the thickness increasing portion, by a press processing.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an endoscope according to a first embodiment of the present invention;

FIG. 2 is a perspective view showing a protruding type of bending part and a boring type of bending part according to the first embodiment of the present invention;

FIG. 3 is a longitudinal cross-sectional view showing a bending tube according to the first embodiment of the present invention;

FIG. 4A is a side view showing the protruding type of bending part according to the first embodiment of the present invention;

FIG. 4B is a transverse cross-sectional view showing the protruding type of bending part according to the first embodiment of the present invention along IVB-IVB line in FIG. 3;

FIG. 5A is a side view showing the boring type of bending part according to the first embodiment of the present invention;

FIG. 5B is a transverse cross-sectional view showing the boring type of bending part according to the first embodiment of the present invention along VB-VB line in FIG. 3;

FIG. 6 is a top view showing a pilot hole forming step according to the first embodiment of the present invention;

FIG. 7A is a top view showing a thickness unevenly varying step according to the first embodiment of the present invention;

FIG. 7B is a transverse cross-sectional view showing the thickness unevenly varying step according to the first embodiment of the present invention along VIIB-VIIB line in FIG. 7A;

FIG. 8A is a top view showing a protruding portion forming step according to the first embodiment of the present invention;

FIG. 8B is a transverse cross-sectional view showing the protruding portion forming step according to the first embodiment of the present invention along VIIIB-VIIIB line in FIG. 8A;

FIG. 9 is a top view showing a wire receiving portion forming step according to the first embodiment of the present invention;

FIG. 10 is a top view showing a tubular portion preparing portion forming step according to the first embodiment of the present invention;

FIG. 11 is a top view showing a first edge removing step according to the first embodiment of the present invention;

FIG. 12 is a top view showing a coupling step according to the first embodiment of the present invention;

FIG. 13 is a top view showing a second edge removing step according to the first embodiment of the present invention;

FIG. 14 is a top view showing a tubular portion forming step according to the first embodiment of the present invention;

FIG. 15 is a schematic view showing the thickness unevenly varying step at the time of starting according to the first embodiment of the present invention;

FIG. 16 is a schematic view showing the thickness unevenly varying step at the time of ending according to the first embodiment of the present invention;

FIG. 17 is a schematic view showing the protruding portion forming step at the time of starting according to the first embodiment of the present invention;

FIG. 18 is a schematic view showing the protruding portion forming step at the time of ending according to the first embodiment of the present invention;

FIG. 19 is a schematic view showing a protruding portion in a metal plate according to the first embodiment of the present invention;

FIG. 20 is a schematic view showing a protruding portion forming step at the time of starting according to a comparison embodiment;

FIG. 21 is a schematic view showing the protruding portion forming step at the time of ending according to the comparison embodiment;

FIG. 22 is a schematic view showing a thickness unevenly varying step according to a second embodiment of the present invention;

FIG. 23 is a schematic view showing a thickness unevenly varying step according to a first modified example of the second embodiment of the present invention;

FIG. 24 is a schematic view showing a metal mold according to a second modified example of the second embodiment of the present invention; and

FIG. 25 is a schematic view showing a metal mold according to a third embodiment of the present invention.

### DETAILED DESCRIPTION OF THE INVENTION

Hereinafter, each embodiment of the present invention will be explained referring to the drawings.

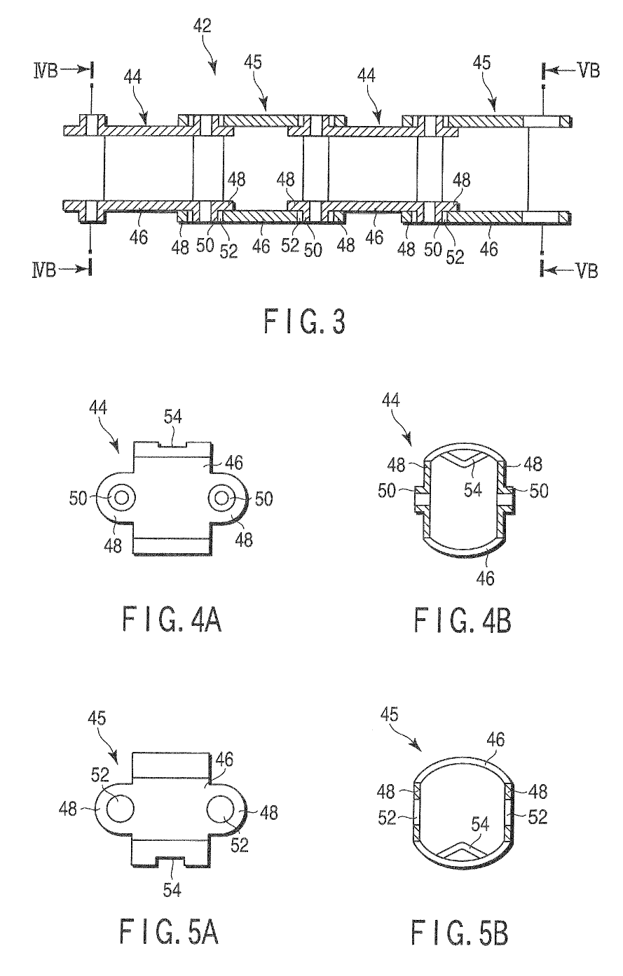

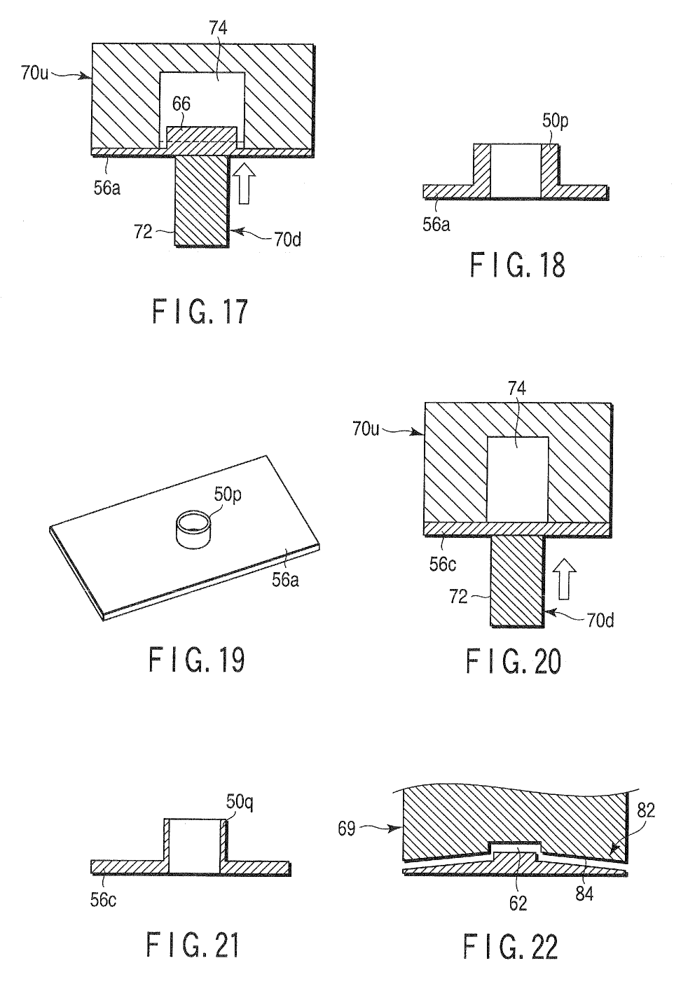

FIGS. 1 to 21 show a first embodiment of the present invention.

Referring to FIG. 1, a schematic structure of an endoscope will be explained.

The endoscope includes an elongated insertion portion 30 configured to be inserted into a cavity in the body. In the insertion portion 30, a distal end rigid portion 32, a bending portion 34 configured to be actuated to be bent and an insertion tube portion 36 being long and flexible are provided from the distal end side to the proximal end side. An operation portion 38 is coupled to the distal end portion of the insertion portion 30 and is configured to be held and operated by an operator. A bending operation lever 40 is provided in the operation portion 38 and configured to actuate the bending portion 34 to be bent.

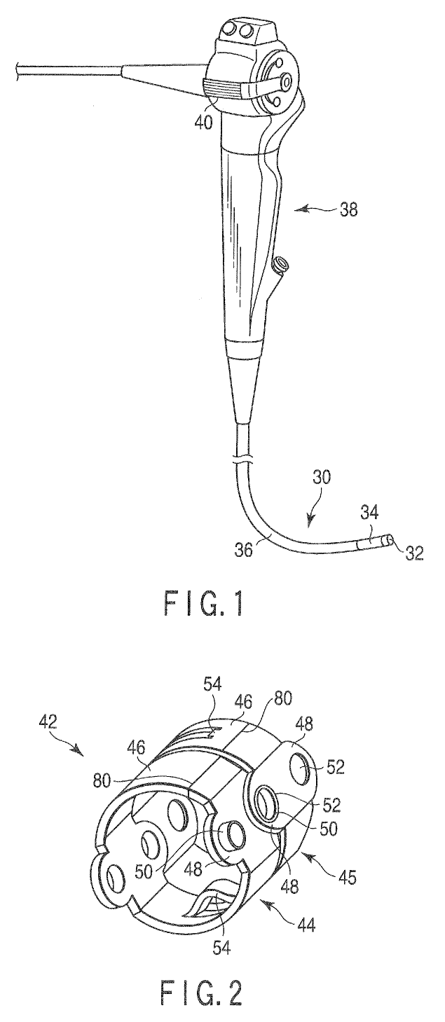

Referring to FIGS. 2 to 5B, a bending tube 42 forming a framework of the bending portion 34 will be explained.

In the bending tube 42, a great number of substantially tubular bending parts 44 and 45 are coupled to each other so as to be coaxial and rotatable relative to each other in order. That is, in the bending part 44 or 45, both pairs of tongue portions 48 symmetrical with each other relative to the central axis are axially protruded from both the end surfaces of a tubular portion 46, respectively. It is noted that the tubular portion 46 and the tongue portion 48 forms a main portion of the bending part 44 or 45. Both the pairs of tongue portions 48 of one bending part 44 and the other bending part 45 adjacent to each other are overlapped with each other, and the tongue portion 48 of the one bending part 44 is arranged on the radial inside and the tongue portion 48 of the other bending part 45 is arranged on the radial outside. A circularly tubular protruding portion 50 as an extending portion is radially and outwardly extended from the radially outside surface of the tongue portion 48 in the one bending part 44. A through bore 52 is radially formed through the tongue portion 48 in the other bending part 45. The protruding portion 50 of the one bending part 44 is fit into the through bore 52 of the other bending part 45 so as to be rotatable about the central axis of the protruding portion 50, and the one bending part 44 and the other bending part 45 are rotatable relative to each other. Hereinafter, out of both the bending parts 44 and 45 to be coupled to each other so as to be rotatable relative to each other, regarding the tongue portions 48 and 48 to be overlapped with each other, the bending part 44 in which the protruding portion 50 is radially and outwardly formed is referred to as the protruding type of bending part 44 and the bending part 45 in which the through bore 52 into which the protruding portion 50 is fitted is radially formed is referred to as the boring type of bending part 45.

Moreover, a wire receiving portion 54 is provided in each bending part 44 or 45. That is, in the tubular portion 46, a part of the tubular portion 46 peripherally extended is radially and inwardly extended so as to form a V-shape when axially viewed, and the V-shaped portion forms a wire receiving portion 54. An operation wire for actuating the bending portion 34 to be bent is inserted through the wire receiving portion 54.

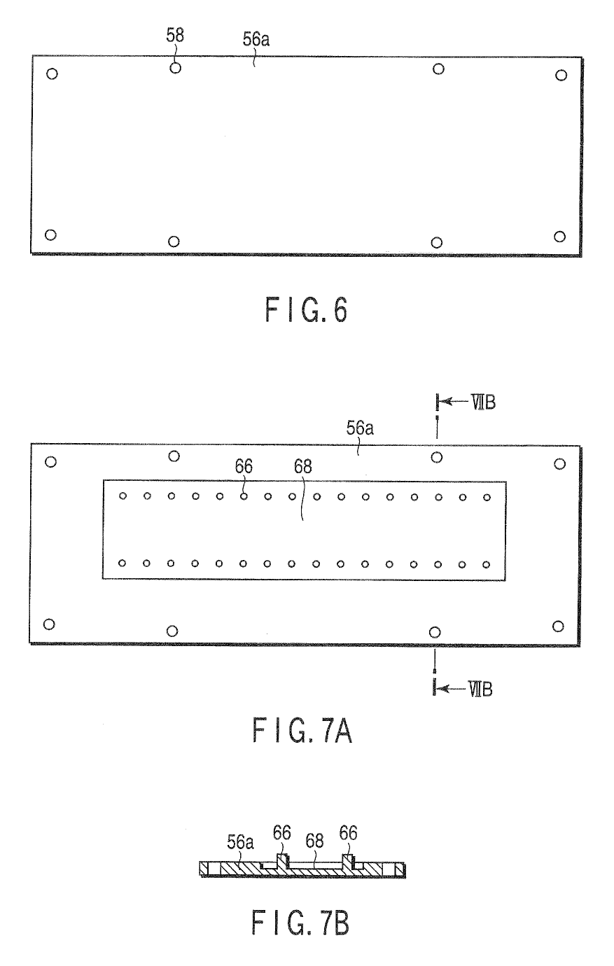

Referring to FIGS. 6 to 21, a method for manufacturing the bending tube 42 by a press processing will be explained.

A preparing step

A metal plate as a board-shaped member is prepared. A board thickness of the metal plate is set to be greater than a board thickness of the tubular portion 46 of the bending part 44 or 45. For example, a board thickness of the metal plate is set to be 1.1-1.5 times as great as a board thickness of the tubular portion 46.

A pilot hole forming step (referring to FIG. 6)

Pilot holes 58 are formed through the metal plate 56A by a punching processing. In the embodiment, a pair of pilot holes 58 are arranged to be opposite to each other on both the edge portions in the wide direction of the metal plate 56A, a plurality of the pairs of pilot holes 58 are arranged along the axial direction of the metal plate 56A. The pilot holes 58 are adapted to position the metal plate 56A relative to a progressive press processing metal mold configured to perform a progressive press processing in each of the following steps.

A thickness unevenly varying step (referring to FIGS. 6, and 7A and 7B)

Also referring to FIGS. 15 and 16, in a metal mold 69 used in the thickness unevenly varying step, a thickness increasing portion forming portion 62 and a thickness decreasing portion forming portion 64 are formed on a pressing side shaping surface, that is, a pressing surface configured to press the upper surface side of the metal plate 56A. The thickness increasing portion forming portion 62 increases a board thickness of the metal plate 56A more than the original board thickness thereof to form a thickness increasing portion 66, and the thickness decreasing portion forming portion 64 decreases a board thickness of the metal plate 56A more than the original board thickness thereof to form a thickness decreasing portion 68. That is, the thickness increasing portion forming portion 62 has a circular plate-shaped concave shape whose central axis is substantially parallel to a pressing direction, and the thickness decreasing portion forming portion 64 is arranged around the thickness increasing portion forming portion 62 and has a shape of a plate surface substantially parallel to the upper surface, that is, a surface to be shaped of the metal plate 56A. When performing a press processing with the metal mold 69, the thickness decreasing portion forming portion 64 is pressed near the center between the pair of pilot holes 58 arranged opposite to each other on the edge portions in the metal plate 56A. The part on which the thickness decreasing portion forming portion 64 was pressed is shown as a rectangular part in a top view of FIG. 7A. In this part, a board thickness is decreased while a curvature and the like are straighten, and a board thickness of this part become uniform and substantially equal to a board thickness of the tubular portion 46 of the bending tube 42, and therefore, the thickness decreasing portion 68 is formed. The thickness decreasing portion forming portion 64 decrease a board thickness of the metal plate 56A, and therefore, a material of the metal plate 56A is compressed and hardness is increased in the thickness decreasing portion 68, and also, a part of a material is escaped into the concave shape of the thickness increasing portion forming portion 62, that is, a material is flowed into the thickness increasing portion forming portion 62, and the thickness increasing portion 66 is formed having a circular plate-shaped convex shape reverse to the circular plate-shaped concave shape of the thickness increasing portion forming portion 62. The thickness increasing portion 66 is formed on each part wherein a protruding portion preparing portion 50p for forming the protruding portion 50 of the bending tube 42 will be formed in steps following a next step. Moreover, the thickness decreasing portion 68 is basically formed so as to contain a part wherein a plane board-shaped tubular portion preparing portion 46p for forming the tubular portion 46 and a plane board-shaped tongue portion preparing portion 48p forming the tongue portion 48 will be formed in the steps following the next step.

It is noted that, although the thickness increasing portion 66 having a shape of a circular plate is formed in the embodiment, a thickness increasing portion having any shape of a circular cylinder, an elliptical cylinder, a prism, a circular cone, an elliptical cone, a pyramid and so on may be formed according to a shape of the protruding portion 50.

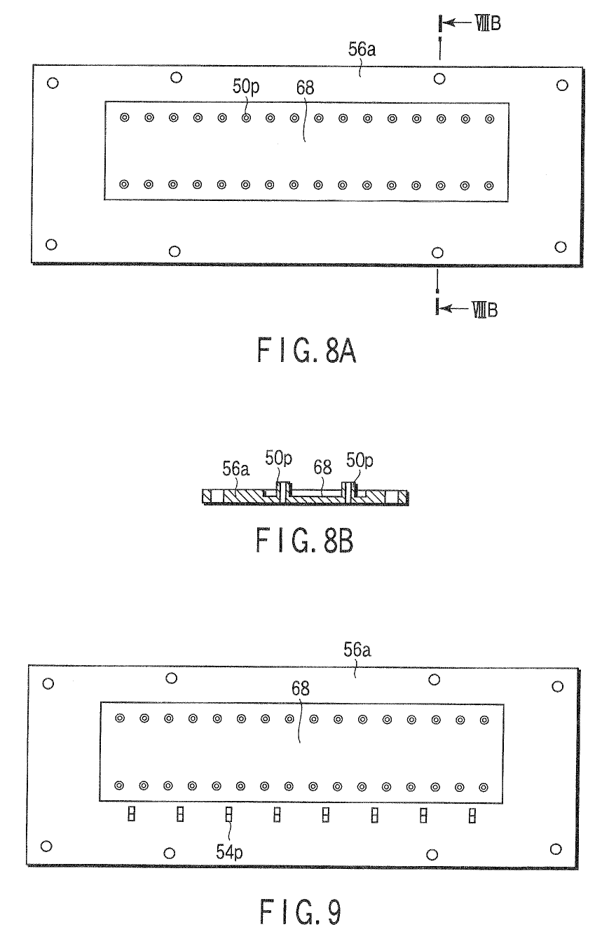

A protruding portion preparing portion forming step (referring to FIGS. 7A and 7B, and 8A and 8B)

Also referring to FIGS. 17 to 19, in the protruding portion preparing portion forming step, a protruding portion preparing portion 50p to form the protruding portion 50 of the bending tube 42 is formed by a burring shaping. A lower mold 70d including a rod-shaped portion 72 and an upper mold 70u including a concave portion 74 that the rod-shaped portion 72 is adapted to be inserted into and pulled out are used as metal molds 70u and 70d. More specifically, the rod-shaped portion 72 of the lower mold 70d and the concave portion 74 of the upper mold 70u has circularly cylindrical shapes whose central axes correspond to a pressing direction, an outer diameter of the rod-shaped portion 72 is substantially equal to an inner diameter of the protruding portion 50, and an inner diameter of the concave portion 74 is substantially equal to an outer diameter of the protruding portion 50. When performing a press processing with the metal molds 70u and 70d, the upper mold 70u is brought into contact with the upper surface of the thickness decreasing portion 68 of the metal plate 56A and the thickness increasing portion 66 is covered with the concave portion 74, and then, the rod-shaped portion 72 of the lower mold 70d is pressed onto the metal plate 56A and moved upward from the lower side of the thickness increasing portion 66, the rod-shaped portion 72 is inserted into the concave portion 74 of the upper mold 70u, a part of the metal plate 56A is extended so as to form a circularly tubular shape upwardly between the rod-shaped portion 72 and the concave portion 74, and therefore, a circularly tubular protruding portion preparing portion 50p is formed, and then, the rod-shaped portion 72 is passed through the metal plate 56A, and therefore, an upper end opening of the protruding portion preparing portion 50p is formed. In this may, the protruding portion preparing portion 50p is formed in each part in which the thickness increasing portion 66 was formed. Regarding the protruding portion preparing portion 50p formed in such manner, a radial thickness in the circularly tubular protruding portion preparing portion 50p is greater than a board thickness in the thickness decreasing portion 68, and therefore, a sufficient thickness and sufficient strength are secured in the protruding portion preparing portion 50p. Referring to FIGS. 20 and 21, in the case where a metal plate 56c whose board thickness is substantially equal to a board thickness of a tubular portion 46 is used as a metal plate and a protruding portion preparing portion 50q is formed by a burring shaping without forming a thickness increasing portion 66, a thickness in the protruding portion preparing portion 50q is thin and it is difficult to secure sufficient strength in the protruding portion preparing portion 50q.

A wire receiving portion preparing portion forming step (Referring to FIGS. 8A and 8B, and 9)

In the metal plate 56A, parts between the edge portions in the wide direction of the metal plate 56A and the thickness decreasing portion 68 has an initial board thickness. In such part between one edge portion and the thickness decreasing portion 68, shapes of V are formed by a cutting and bending processing from the upper side to the lower side with a metal mold (not shown), and therefore, wire receiving portion preparing portions 54p to form the wire receiving portion 54 are shaped.

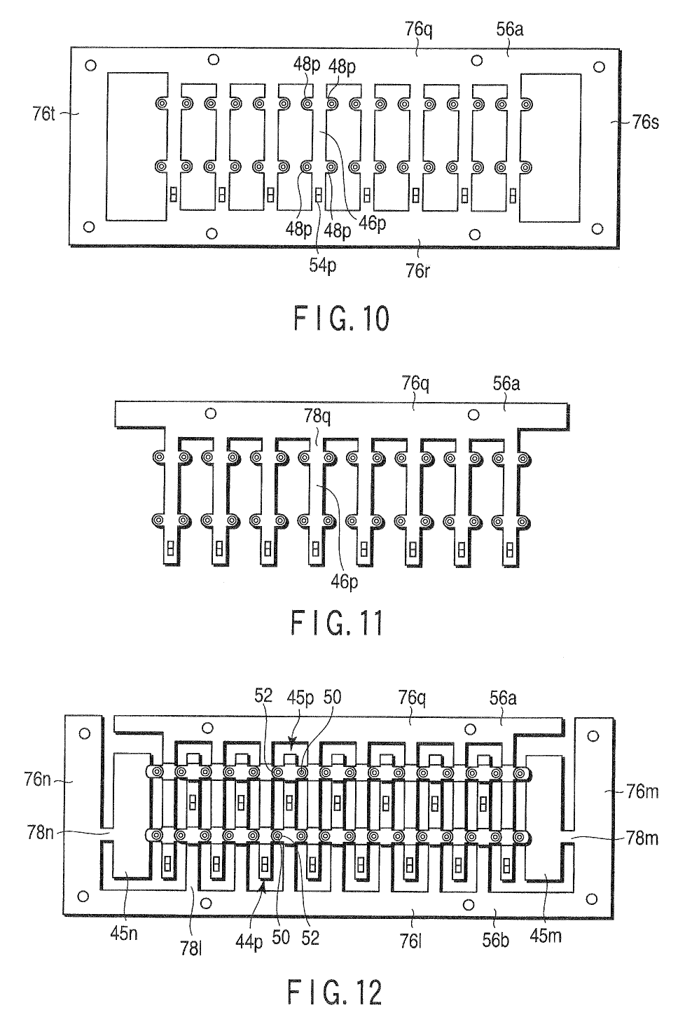

A tubular portion preparing portion forming step (referring to FIGS. 9 and 10)

A punching processing is performed to the metal plate 56A to form a plane board-shaped tubular portion preparing portion 46p for forming the tubular portion 46 of the bending tube 42 and a plane board-shaped tongue portion preparing portion 48p for forming the tongue portion 48 thereof. Although the tubular portion preparing portion 46p and the tongue portion preparing portion 48p is basically formed from the thickness decreasing portion 68, a part of the tubular portion preparing portion 46p in which a wire receiving portion preparing portion 54p is formed is formed from a part having an initial board thickness.

It is noted that a region of the thickness decreasing portion 68 is not shown in FIGS. 10 to 14.

A first edge removing step (referring to FIGS. 10 and 11)

The edge portions 76r, 76s and 76t other than the edge portion 76q on one side out of the edge portions 76q, 76r, 76s and 76t of the metal plate 56A are cut to be removed with a metal mold (not shown). The edge portion 76q on the one side supports the tubular portion preparing portion 46p through supporting strip portions 78q.

A coupling step (referring to FIGS. 11 and 12)

Through the steps from the preparing step to the first edge removing step, each protruding type of bending part preparing portion 44p for forming the protruding type of bending part 44 of the bending tube 42 is formed in the metal plate 56A. On the other hand, each boring type of bending part preparing portion 45p for forming the boring type of bending part 45 of the bending tube 42 is formed in another metal plate 56B. In the other metal plate 56B, regarding edge portions, edge portions 76m and 76n on both the end portions supporting the boring type of bending part preparing portions 45m and 45n on both the ends through the supporting strip portions 78m and 78n and edge portion 76l on the other side supporting each boring type of bending part preparing portion 45p other than the boring type of bending part preparing portions 45m and 45n on both the ends through supporting strip portions 78l is not cut to be remained. In the coupling step, both the metal plates 56A and 56B are overlapped with each other, and the protruding portion preparing portion 50p of the protruding type of bending part preparing portion 44p is fitted into the through bore 52 of the boring type of bending part preparing portion 45p, and therefore, each protruding type of bending part preparing portion 44p and each boring type of bending part preparing portion 45p are coupled to each other.

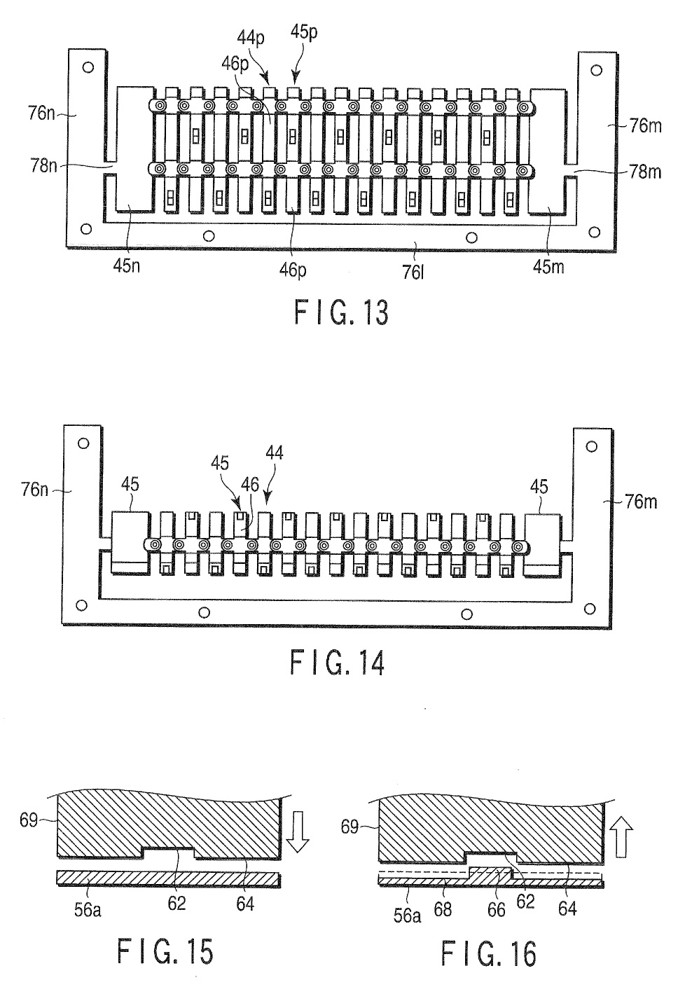

A second edge removing step (referring to FIGS. 12 and 13)

The whole edge portion 76q supporting the protruding type of bending part preparing portion 44p and the supporting strip portions 78l of the edge portion 76l supporting each boring type of bending part preparing portion 45p other than the boring type of bending part preparing portions 45m and 45n on both the ends are cut to be removed with a metal mold (not shown).

A tubular portion forming step (referring to FIGS. 13 and 14)

Each tubular portion preparing portion 46p of each protruding type of bending part preparing portion 44p and each boring type of bending part preparing portion 45p coupled to each other is shaped to be a tubular shape about an axis of a coupling direction through an U-bending processing and an O-bending processing to form the tubular portion 46.

A third edge removing step

Regarding the boring type of bending parts 45 formed from the boring type of bending part preparing portions 45m and 45n on both the ends, the edge portions 76m and 76n (referring to FIG. 12) supporting the boring type of bending parts 45 on both the ends are cut to be removed from the boring type of bending parts 45.

Through the above steps from the preparing step to the third edge removing step, the bending tube 42 is manufactured. A part of the bending tube 42 is shown in FIG. 2. In the bending tube 42, the protruding portion preparing portion 50p, the wire receiving portion preparing portion 54p and the tongue portion preparing portion 48p formed in each steps of the progressive press processing form the protruding portion 50, the wire receiving portion 54 and the tongue portion 48.

It is noted that, as is shown in FIG. 2, after the third edge removing step, both the end portions from which the edge portion 76r or 76q, or the supporting strip portion 78l or 78q is cut away are in contact with each other to form a contact portion 80 in the tubular portion 46, and the contact portion 80 is adhered through a joining processing such as a laser welding, a bonding and so on.

As is mentioned above, in the method for manufacturing the endoscope bending tube 42 according to the embodiment, the thickness increasing portion 66 is formed in the metal plate 56A, the protruding portion preparing portion 50p is formed in the thickness increasing portion 66 by the burring shaping, and the protruding portion 50 is manufactured. Therefore, a thickness of the protruding portion 50 is not too thin and sufficient strength of the protruding portion 50 is secured. Moreover, the thickness decreasing portion 68 is formed together with the thickness increasing portion 66, and the tubular portion 46 and the tongue portion 48 having high hardness are formed from the thickness decreasing portion 68. Therefore, a firm endoscope bending tube 42 is manufactured.

FIGS. 22 to 24 show a second embodiment of the present invention, and a first and a second modified example thereof.

Referring to FIG. 22, in the embodiment, an inclining portion 82 as a thickness decreasing portion forming portion is formed around a thickness increasing portion forming portion 62 and inclines in an opposite direction to a pressing direction of a metal mold 69 toward a thickness increasing portion 66 in a pressing side shaping surface of the metal mold 69. The inclining portion 82 includes an inclining surface 84 having an angle of inclination of 1-5 degrees. When performing a press processing with the metal mold 69, a material of a metal plate 56A is flowed toward the thickness increasing portion forming portion 62 along the inclining portion 82, and therefore, it is possible for a material to smoothly and securely flow to the thickness increasing portion forming portion 62.

Referring to FIG. 23, in the modified example, instead of the inclining surface 84, a gentle inclining curved surface 86 having a convex shape toward the side on which a metal plate is arranged and having a sufficient great radius of curvature is formed in an inclining portion 82 as a thickness decreasing portion forming portion.

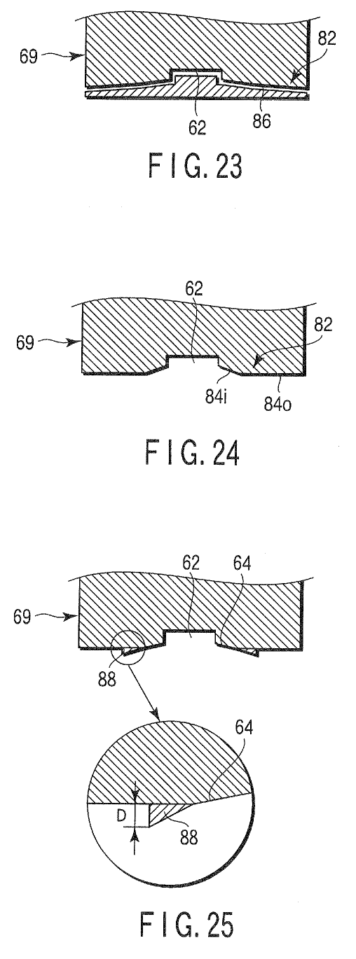

Referring to FIG. 24, in the modified example, an inside inclining surface 84i having an angle of inclination of 3-5 degrees is formed continuously with a thickness increasing portion forming portion 62 and near it and an outside inclining surface 84o having an angle of inclination of 2-3 degrees is formed around the inside inclining surface 84I in the inclining portion 82.

FIG. 25 shows a third embodiment of the present invention.

In the embodiment, an inclining surface having an angle of inclination of 3-5 degrees is formed as a thickness decreasing portion forming portion 64, continuously with a thickness increasing portion forming portion 62, and around it in a pressing side shaping surface in a metal mold 69. A wedge portion 88 as a partition portion is formed on the whole periphery of the outer edge of the thickness decreasing portion forming portion 64. Regarding a thickness of the wedge portion 88, a thickness on the side close to the thickness decreasing portion forming portion 64, that is, the inner peripheral side of the wedge portion 88 is thinner and a thickness on the side opposite to the thickness decreasing portion forming portion 64, that is, the outer peripheral side of the wedge portion 88 is thicker, and a thickness on the opposite side D is 1/10 of a board thickness of the metal plate 56A and below. When performing a press processing with the metal mold 69, out of a material forming the metal plate 56A, only a material on the inside of the wedge portion 88 flows toward the thickness increasing portion forming portion 62 and a material on the outside of the wedge portion 88 does not flow. Therefore, an unnecessary flow of a material is prevented.

Although a thickness increasing portion is formed in order to form a protruding portion 50 of a bending part in the above embodiments, a thickness increasing portion may be formed in order to form various extending portions extended from a main portion of a bending part, for example, a thickness increasing portion may be formed in order to form a wire receiving portion.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for manufacturing an endoscope bending tube from a board-shaped member by a press processing wherein the endoscope bending tube includes a plurality of bending parts each of which includes a tubular main portion and an extending portion extended from the main portion,
the method comprising:
forming a thickness increasing portion in which a thickness is locally increased, on the board-shaped member, by a press processing; and
forming the extending portion in the thickness increasing portion, by a press processing.

2. The method for manufacturing the endoscope bending tube according to claim 1,
wherein the method includes using a board-shaped member whose board thickness is greater than a board thickness of the main portion, as the board-shaped member, and
the forming the thickness increasing portion includes: moving a part of a material forming the board-shaped member in the board-shaped member to form the thickness increasing portion thicker than the board thickness of the board-shaped member; and forming a thickness decreasing portion thinner than the board thickness of the board-shaped member and whose board thickness is substantially equal to the board thickness of the main portion in at least a part other than the thickness increasing portion in the board-shaped member.

3. The method for manufacturing the endoscope bending tube according to claim 2,
wherein the forming the thickness increasing portion includes: using a metal mold whose shaping surface including a concave portion; and pressing the metal mold onto the board-shaped member to move a part of the material forming the board-shaped member into the concave portion to form the thickness increasing portion and the thickness decreasing portion.

4. The method for manufacturing the endoscope bending tube according to claim 3,
wherein the metal mold includes an inclining portion formed around the concave portion and inclining in an opposite direction to a pressing direction of the metal mold toward the concave portion.

5. The method for manufacturing the endoscope bending tube according to claim 4,
wherein the metal mold includes a partition portion configured to limit a range in which a material is to be moved to form the thickness increasing portion.

6. The method for manufacturing the endoscope bending tube according to claim 1,
wherein the forming the extending portion includes performing a burring shaping.

7. The method for manufacturing the endoscope bending tube according to claim 1,
wherein the extending portion includes a coupling protruding portion for coupling the plurality of bending parts to each other so as to be rotatable relative to each other.

8. An endoscope bending tube comprising a plurality of bending parts each of which includes a tubular main portion and an extending portion extended from the main portion,
wherein the extending portion includes a circularly tubular protruding portion formed by a burring processing to a section of the main portion, and
a radial thickness in the protruding portion is greater than a thickness of the main portion.
